(19) United States
(12) Patent Application Publication
(10) Pub. No.: US 2008/0012953 A1
(43) Pub. Date: Jan. 17, 2008

(54) Image Sensors

(75) Inventors: Dave Xiao Dong Yang, Beijing (CN); Zhonghan Deng, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/457,150

(22) Filed: Jul. 13, 2006

(51) Int. Cl. H04N 5/228

(52) U.S. Cl. 348/222.1

(57) ABSTRACT

Architecture of an integrated image sensor is disclosed. The image sensor includes an interface to transport image data out of the sensor directly to a host computing device. To accommodate the required data transfer speed, a raw image (e.g., a Bayer pattern image) from the sensor is directly digitized, compressed if the resolution thereof exceeds a range, and output via the interface. A color image of the scene is reconstructed from the raw image in the host computing device.

### BACKGROUND OF THE INVENTION

1. Field of the Invention

The present invention is related to the area of image sensors. More particularly, the present invention is related to architectures of image sensors utilizing resources in a host computing device to reconstruct a color image from a raw image (e.g., a Bayer pattern image).

2. Description of Related Art

There are many devices equipped with a camera, for example, cell phones, computers, and PDAs to facilitate visual communications. Nearly all cameras use either CCD or CMOS image sensors. FIG. 1 shows a prior art CMOS image sensor 100 coupled to a digital signal processor (DSP) 102 in order to provide image data via an interface 104 such as a Universal Serial Bus or USB. The CMOS image sensor 100 includes a sensor array 106, one or more analog-to-digital converters (ADC) 108, and a color processing unit 110. When the sensor array 106 operates and is exposed to a scene, it generates an array of analog signals representing the scene. The analog signals are then digitized by the analog-to-digital converters 108 to produce image data. The color processing unit 110 is provided to ensure proper outputs from the image sensor 100 are produced. One exemplary function provided by the color processing unit 110 is to generate a color image from the image data. Another exemplary function provided by the color processing unit 110 is to produce separated components (e.g., RGB signals or YUV signals).

To accommodate the data transferring speed limited by the USB, the image data must be compressed before being read out via the USB. Accordingly, the DSP 102 is designed to include a JPEG module 112. Operationally, for the JPEG module 112 to function properly on the image data received from the image sensor 100, the DSP 102 has to include many other modules including a CPU (not shown) to process the image data (e.g., separated components YUV) before the image data is compressed in the JPEG module 112. Examples of the modules include contrast, brightness, and chrominance processing.

In addition to the commonly used modules, such as Auto-Gain Control (AGC) and Gamma correction, shown as an image signal processing (ISP) module 114, the modules facilitating the JPEG module 112 to function properly can make the DSP 102 quite complicated, which is part of the reasons that the image sensor 100 and the DSP 102 are not commonly integrated on a single chip.

Given the limited space available in many devices, especially the portable devices, to accommodate a camera, such a two-chip solution as shown in FIG. 1 could be sometimes awkward. One example is a laptop computer where it is often desirable to have a camera disposed near the edge of a display screen so that a user can communicate with others visually. However, the physical size of such a display screen is already limited, demanding an additional space to house the two chips and other auxiliary circuits can be challenging.

There is, thus, a great need for an image sensor that is amenable to a small footprint, enhanced impact performance, lower cost, and easier manufacturing process.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to an integrated image sensor that includes an interface to transport image data out of the sensor directly to a host computing device. To accommodate the required data transfer speed, a raw image from the sensor is directly digitized, compressed and output via the interface. An exemplary raw image is a Bayer pattern image thus a color image of the scene is reconstructed from the Bayer pattern image in the host computing device.

According to one aspect of the present invention, an image sensor includes a sensor array that produces analog signals representing a raw image (e.g., a Bayer pattern image) when operating and exposed to a scene, one or more analog-to-digital converters are used to be coupled to the sensor array, converting the analog signals to digital signals. A compressor coupled to the analog-to-digital converters to compress the digital signals to produce compressed data representing a digital version of the Bayer pattern image, and an interface is then provided to read out the compressed data.

The present invention may be implemented as a device and a part of a system. According to one embodiment, the present invention is a device comprising a memory, a processor coupled to the memory, a display screen and a camera disposed near an edge of the display screen to capture a user of the device. The camera comprises a sensor array producing analog signals representing a raw image (e.g., a Bayer pattern image) of the user when operating and exposed to the user, one or more analog-to-digital converters, coupled to the sensor array, converting the analog signals to digital signals. Should the image resolution of the raw image exceed a certain range, a compressor is provided to compress the digital signals to produce compressed data representing a digital version of the raw image, and an interface provided to read out the compressed data to the memory. The processor is caused to execute a software module to decompress the compressed data and proceed with reconstructing a color image from the digital version of the Bayer pattern image.

One of the features, benefits and advantages in the present invention is to provide an integrated image sensor that is amenable to a small footprint, enhanced impact performance, lower cost, and easier manufacturing process.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows a prior art CMOS image sensor coupled to a digital signal processor (DSP) in order to provide image data via an interface such as a Universal Serial Bus or USB;

FIG. 2 is a functional block diagram of an exemplary image sensor according to one embodiment of the present invention; and

FIG. 3 shows that each of photo elements in a sensor array is superimposed with a colored filter in accordance with a Bayer filter mosaic; and

FIG. 4 shows exemplary internal construction blocks of a computing device in which the present invention may be implemented and executed.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

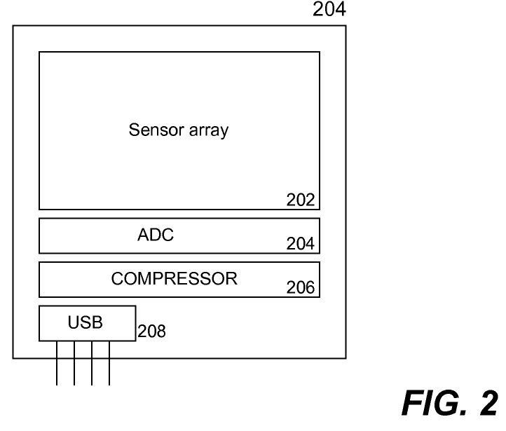

FIG. 2 is a functional block diagram of an exemplary image sensor 200 according to one embodiment of the present invention. The image sensor 200 includes a sensor array 202, one or more analog-to-digital converters (ADC) 204, a compressor 206, and a USB interface 208. In one embodiment, the image sensor 200 is a CMOS sensor, the resolutions of which may be of 1.3M pixels, 3.0M pixels or higher. The analog-to-digital converters 204 may provide a precision of 6-bits, 8-bits or 10-bits depending on application to convert analog signals generated in the sensor to image data. To facilitate the image data output from the USB interface 208, the compressor 206 is provided to compress image data from by the analog-to-digital converters 204. It should be noted that, in one embodiment, the compressor 206 may not be needed if the image resolution (e.g., VGA) is not high enough as the bandwidth of the USB interface 208 may be sufficient to transfer the image data.

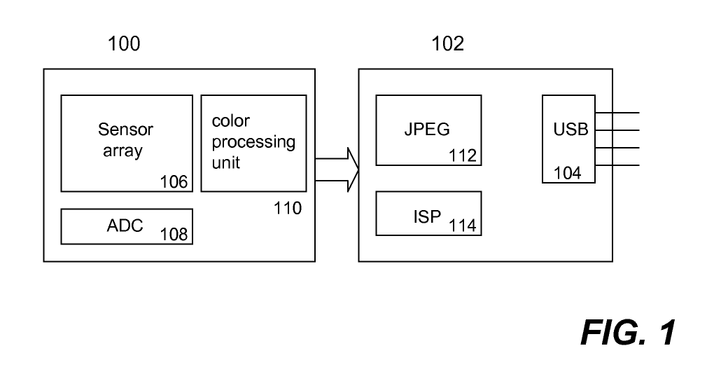

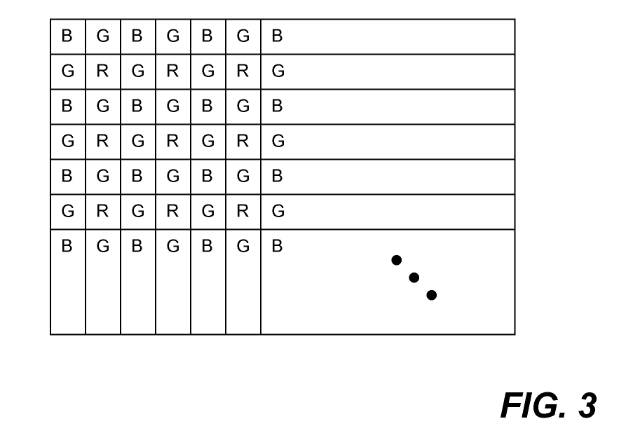

Significantly different from FIG. 1, there are no other modules to facilitate the operation of the compressor 206 in FIG. 2. The compressor 206 operates directly on the digitized data from the analog-to-digital converters 204. According to one embodiment, the image sensor 200 is a color sensor in a sense that there are color filters on the photo elements. Specifically, as shown in FIG. 3, each of the photo elements is superimposed with a colored filter. Filters of three primary colors, such as red (R), green (G) and blue (B), are used in one embodiment. The way how the color filters are arranged or the filter pattern is commonly referred to as a Bayer filter mosaic which means a color filter array (CFA) for arranging the RGB color filters uniquely on a grid of photo elements. The term derives from the name of its inventor, Bryce Bayer of Eastman Kodak, and refers to the filter pattern being 50% green, 25% red and 25% blue, hence is also called RGBG or GRGB pattern. A detailed description of the Bayer filter mosaic is provided in U.S. Pat. No. 3,971,065 which is hereby incorporated by reference.

Bayer uses twice as many green elements as red or blue to mimic the human eye's greater resolving power with green light. These elements are referred to as samples, and become pixels after interpolation. The raw output of a Bayer sensor is referred to as a Bayer pattern image. Since each pixel is filtered to record only one of the three colors, two-thirds of the color data is missing from each point. To obtain a full-color image, various demosaicing algorithms can be used to reconstruct a set of complete red, green, and blue values for each point.

Different algorithms of image reconsruction requiring various amounts of computing power result in varying-quality final images. The sensor 106 of FIG. 1 performs the computation and produces the image data for producing a JPEG image in the DSP 102. However, the compressor 206 is configured to operate directly on the Bayer pattern image from the sensor array 202.

In one embodiment, the compressor 206 is based on ADPCM, short for Adaptive Differential Pulse Code Modulation. ADPCM is a form of pulse code modulation (PCM) that produces a digital signal with a lower bit rate than standard PCM. ADPCM produces a lower bit rate by recording only the difference between samples and adjusting the coding scale dynamically to accommodate large and small differences. Depending on implementation, ADPCM can be implemented in one or two dimentions.

As a result, the compressor 206 produces compressed Bayer pattern image that is much smaller in size and applicable for transferring via the USB 208. It is understood that because each pixel in a Bayer pattern image is filtered to record only one of the three colors, two-thirds of the color data is missing from each point. Accordingly, the Bayer pattern image is only about one third of a color image that is otherwise reconstructed from the Bayer pattern image as the image sensor 102 of FIG. 1 does. With the compressor 206, the Bayer pattern image is further reduced in size. Depending on the image quality requirement, the Bayer pattern image can be compressed by another 25%˜40%.

According to one embodiment, the USB 208 is based on the Universal Serial Bus 2.0, an overhaul of the Universal Serial Bus input/output bus protocol which allows much higher speeds than the older USB 1.1 standard does. USB 1.1 allows a maximum transfer rate of 12 Mbits/second while USB 2.0 (high speed) is capable of a much faster 480 Mbits/second. Even with the requirement of 60 frames per second from the sensor array 202, USB 2.0 is sufficient for transferring compressed Bayer pattern images for sensors of most commonly used resolutions, and uncompressed Bayer pattern images for sensors of certain resolutions.

A compressed Bayer pattern image from the USB 208 is essentially an un-interpolated data image where each pixel corresponds to only one specific color value. In order to get a color image, the colors have to be “reconstructed” based on the Bayer data. Traditionally, the reconstruction is done in hardware to accommodate the required speed. As seen above, the compressed Bayer pattern image has now been read out from the USB 208, a sufficient computing resource has to be allocated to perform the reconstruction.

Nowdays many computing devices are equipped with a powerful processor. For example, most of the latest laptop computers are equipped with either a Pentium 4 processor from Intel or a Turion 64 processor from AMD, both are sufficient to provide the necessary computation power to perform the reconstruction of a color image from a compressed Bayer pattern image. Alternatively, some computing devices are equipped with a graphics chip that may be also used to supplement the computing power needed to perform the reconstruction of a color image from a compressed Bayer pattern image. Before the reconstruction of the color image starts, the compressed Bayer pattern image is first uncompressed to recover the Bayer pattern image.

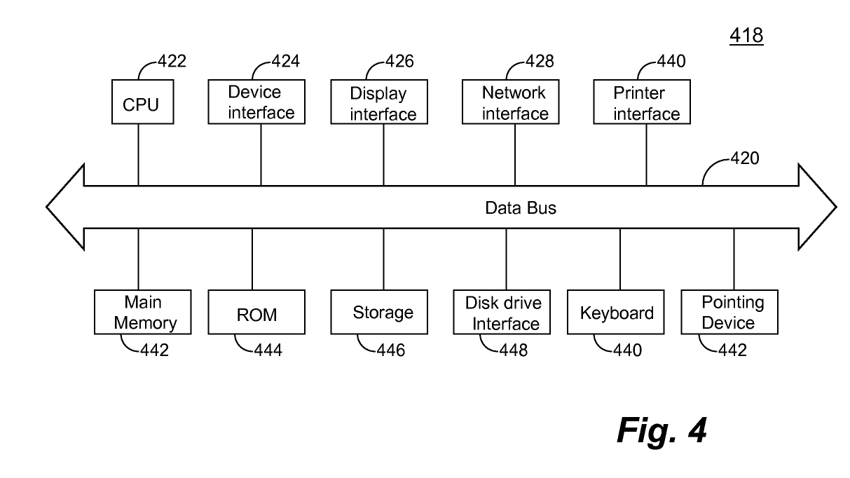

FIG. 4 shows exemplary internal construction blocks of a computing device 418 in which the present invention may be implemented and executed. The system 418 may correspond to a laptop on which the image sensor 200 of FIG. 2 may be embodied. As shown in FIG. 4, the system 418 includes a central processing unit (CPU) 422 interfaced to a data bus 1420 and a device interface 424. The CPU 422 executes certain instructions to manage all devices and interfaces coupled to data bus 420 for synchronized operations. The device interface 424 may be coupled to an external device such as a PC camera incorporating the image sensor 200 of FIG. 2, and receive the compressed Bayer pattern image.

Also interfaced to the data bus 420 is a display interface 426, a network interface 428, a printer interface 440 and a disk drive interface 448. Generally, a compiled and linked version, an executable version, or a software module performing the reconstruction of a color image from a compressed Bayer pattern image is loaded into the storage space 446 through the disk drive interface 438, the network interface 428, the device interface 424 or other interfaces coupled to the data bus 420.

The main memory 442 such as random access memory (RAM) is also interfaced to the data bus 420 to provide the CPU 422 with the instructions and access to storage space 446 for data and other instructions, applications or services. In particular, when executing stored application program instructions, such as the software module of the present invention, the CPU 422 is caused to decompress the compressed Bayer pattern image received from the device interface 424 and proceed with the reconstruction of the color image from the uncompressed Bayer pattern image. The color image may be subsequently displayed on a display screen (not shown) via a display interface 426.

The ROM (read only memory) 444 is provided for storing invariant instruction sequences such as a basic input/output operation system (BIOS) for operation of the keyboard 440, the display 426 and the pointing device 442, if there are any. In general, the system 418 is coupled to a network and configured to provide one or more resources to be shared with or executed by another system on the network or simply as an interface to receive data and instructions from a human being. In one application, the reconstructed image can be transported to another site via the network.

Those skilled in the art can appreciate that the image sensor 200 of FIG. 2 has a far less number of pins than the image sensor 100 of FIG. 1 does. Besides the pins that are need to receive various control, power and ground, the image sensor 100 of FIG. 1 needs an array of pins to read out the image data to the DSP of 102 of FIG. 1. In contrast, the image sensor 200 of FIG. 2 is equipped with a USB interface that has two connectors besides a ground and a power connector. Depending on implementation, the image sensor 200 needs none, one or very few additional pins to receive a control signal or other signals/data, resulting in a small footprint, enhanced impact performance, lower cost, and easier manufacturing process.

Although exemplary embodiments of the present invention have been disclosed in detail, it will be apparent to those skilled in the art that various changes and modifications may be made to achieve the advantage of the invention. It will be obvious to those skilled in the art that some components may be substituted with another component providing same function. For example, a USB interface has been used throughout the description. In practice, other types of interface may be used. Likewise, other type of sensors as well as compressors may be used. In addition, a Bayer pattern is used in the described embodiments. Those skilled in the art can appreciate that other optical filter configurations may be used. Accordingly, the scope of the present invention is defined by the appended claims rather than the foregoing description of embodiments.

I claim:

1. A device comprising:
a sensor array producing analog signals representing a raw image when operating and exposed to a scene;
one or more analog-to-digital converters, coupled to the sensor array, converting the analog signals to digital signals; and
an interface provided to read out data representing the digital signals.

2. The device as claimed in claim 1, wherein the data is transferred to a computing device to which the image sensor is coupled via the interface.

3. The device as claimed in claim 2, further comprising a compressor compressing the digital signals to produce the data, and wherein the computing device includes a software module configured to uncompress the data and reconstruct a color image from the raw image.

4. The device as claimed in claim 3, wherein the raw image is a Bayer pattern image.

5. The device as claimed in claim 4, wherein the Bayer pattern image is filtered to record only one of three primary colors, as a result, two-thirds of color data is missing from each image pixel.

6. The device as claimed in claim 3, wherein the raw image is an un-interpolated data image where each photo element corresponds to only one specific color value.

7. The device as claimed in claim 6, wherein the sensor array is CMOS-based.

8. The device as claimed in claim 7, wherein the compressor is based on Adaptive Differential Pulse Code Modulation (ADPCM).

9. The device as claimed in claim 8, wherein the interface is of one of various versions of USB 2.0.

10. The device as claimed in claim 9, being a single integrated circuit with a number of pins far less than a conventional image sensor.

11. A device comprising:
a memory;
a processor coupled to the memory;
a display screen;
a camera disposed near an edge of the display screen to capture a user of the device, wherein the camera comprises:
a sensor array producing analog signals representing a Bayer pattern image of the user when operating and exposed to the user;
one or more analog-to-digital converters, coupled to the sensor array, converting the analog signals to digital signals;
a compressor compressing the digital signals to produce compressed data representing a digital version of the Bayer pattern image; and
an interface provided to read out the compressed data to the memory, and
wherein the processor is caused to execute a software module to decompress the compressed data and proceed with reconstructing a color image from the digital version of the Bayer pattern image.

12. The device as claimed in claim 11, wherein the color image is displayed on the display screen.

13. The device as claimed in claim 12, wherein the computing device is coupled to a network, and the color image is transported over the network to another device also coupled to the network.

14. The device as claimed in claim 11, wherein the Bayer pattern image is filtered to record only one of three primary colors, as a result, two-thirds of color data is missing from each image pixel.

15. The device as claimed in claim 11, wherein the Bayer pattern image is a monochrome image where each photo element corresponds to only one specific color value.

16. The device as claimed in claim 15, wherein the sensor array is CMOS-based.

17. The device as claimed in claim 16, wherein the compressor is based on Adaptive Differential Pulse Code Modulation (ADPCM).

18. The device as claimed in claim 17, wherein the interface is of USB 2.0.

19. A device comprising:
a sensor array producing analog signals when operating and exposed to a scene;
one or more analog-to-digital converters, coupled to the sensor array, converting the analog signals to digital signals representing a raw image based on a color filter configuration of the sensor array, wherein the raw image itself can not be displayed directly to reflect the scene; and
an interface provided to read out data representing the digital signals.

20. The device as claimed in claim 19, wherein the color filter configuration is in accordance with a Bayer pattern and the raw image is thus a Bayer pattern image.

21. The device as claimed in claim 20, wherein the data is transferred to a computing device to which the sensor array is coupled via the interface.

22. The device as claimed in claim 21, further comprising a compressor compressing the digital signals to produce the data, and wherein the computing device includes a software module configured to uncompress the data and reconstruct a color image from the raw image.
